(19) United States
(12) Patent Application Publication
(10) Pub. No.: US 2023/0415584 A1
(43) Pub. Date: Dec. 28, 2023

(54) EV Driveline

(71) Applicant: Peter Sing, McCleary, WA (US)

(72) Inventor: Peter Sing, McCleary, WA (US)

(21) Appl. No.: 17/847,507

(22) Filed: Jun. 23, 2022

(51) Int. Cl. B60L 15/20; B60L 7/18

(52) U.S. Cl. CPC B60L 15/2045; B60L 7/18

(57) ABSTRACT

This invention is designed to improve the efficiency of modern electric vehicles. This EV driveline will increase the range an electric vehicle can travel per charge. The new EV driveline is comprised of narrow and/or smaller diameter wheels that will greatly reduce drag while driving at cruising speeds. Layout of said wheels will be similar to current vehicles, with wheels on each corner of the vehicle, but can have an extra wheel placed between the front and/or back sets of wheels or possibly in the center of the vehicle.

Extra wheels provide additional friction for gaining speed as well as additional braking power. The number of wheels in the driveline will depend on the users desired acceleration and/or deceleration rate. The extra wheels can be wider, to provide additional friction, or thinner for less drag.

Currently, with internal combustion engines, refueling stations are abundant and refueling only takes moments. With electric vehicles, charging stations are not nearly as abundant and refueling takes hours. This invention will greatly increase the range of modern electric vehicles.

### RELATED APPLICATION

This application claims priority under 35 U.S.C. Section 119(e) to U.S. Provisional Application Ser. No. 63/214,636, filed Jun. 24, 2021 entitled “EV Driveline,” the disclosure of which is incorporated by reference herein in its entirety.

### BACKGROUND OF INVENTION

The premise of this invention is to limit the amount of drag acting upon the vehicle while in motion. In doing so, the energy consumption will be much more efficient and provide more available energy per refueling. This means that there will be much more range available from one charge cycle.

The EV driveline will have wheels positioned in each corner of the vehicle, similar to current vehicles, but will have an additional wheel between each horizontal set of corner wheels. At least one additional wheel will provide additional friction to aid in acceleration and deceleration. When reaching cruising speeds, the additional wheels will retract, leaving only the four corner wheels in contact with the ground.

Each wheel's suspension will be able to raise and lower independently to accommodate for uneven terrain. This will also keep the chassis of the vehicle level no matter how uneven the terrain is. The driveline will use a regenerative braking system to store additional energy, providing additional range. The electric motor will act as a generator whenever not consuming power. That means that every time the car is coasting down a hill or coming to a stop, the motor will become a generator and feed additional energy to the energy storage.

The cruising wheels can be narrower to create less drag to aid in energy conservation. Any of the wheels sizes can vary, depending on the users specific need. Wider wheels to provide additional traction or thinner to create less drag.

### SUMMARY OF INVENTION

This invention is designed to increase the range available in the modern electric vehicle. This can be achieved by reducing drag, using less energy to maintain cruising speeds, and implementing regenerative and generative mechanisms which allow the deceleration of the vehicle to be converted into additional stored energy. Current vehicles use four tires, one near each corner of the vehicle, that are often very wide. This gives the vehicle good traction for acceleration and deceleration, but creates unnecessary drag when traveling at cruising speeds. Similarly, three wheeled vehicles have to use a much wider wheel in the back for additional traction. This very wide wheel creates unnecessary drag while at cruising speeds.

The wheels will be in each corner similar to current automobiles. Between the front two wheels, an additional wheel can be fitted to allow for additional friction to aid in acceleration and deceleration. There can also be an additional wheel fitted between the back sets of wheels for the same purpose. The additional wheels can be added in multiples if necessary.

Each wheel in the driveline will be independently powered by electric motors controlled by the computer via variable frequency drive(s). Motors can be in-hub electric motors. Each wheel will have adjustable suspension, allowing the wheels to raise and lower. This will allow the vehicle to overcome uneven and rough terrain. Also, the vehicle can remain level while traveling on uneven or rough terrain.

The braking system will use a regenerative braking system to allow for generating the energy used to stop the vehicle into stored energy. The electric motors can also transition to a generator when not under load. This means that coasting down a hill, slowing the vehicle, or even letting off of the accelerator will generate additional stored energy. The additional wheels will create less wear on each wheels brake pad/shoes.

The cruising wheels can be narrower to reduce drag which will reduce energy consumption while at cruising speeds. Any of the wheels' sizes can vary, depending on the specific need. Wider wheels will produce more traction, but will add to the drag while at speed. Thinner wheels will reduce drag but will not have as much traction. Additional wheels in the front will aid in braking and additional wheels in the rear will aid in acceleration.

The computer will monitor and control individual wheels speeds, to eliminate the need for a differential gearbox. The wheels speed sensors will also be able to calculate trajectory needed to complete a turn. This can adjust the angle of each front wheel individually depending on the specific need.

### SHORT FIGURE DESCRIPTIONS

FIG. 1A-B is a bottom view of two variations of possible wheel layouts.

FIG. 2A-B is a front view of the single wheel in the center and depicting the raising of said wheel.

FIG. 3A-B is a front view of the double wheels in the center variation and depicting the raising of said wheels.

FIG. 4 is an example of the raising and lowering suspension mechanism.

### DESCRIPTION OF PREFERRED EMBODIMENTS

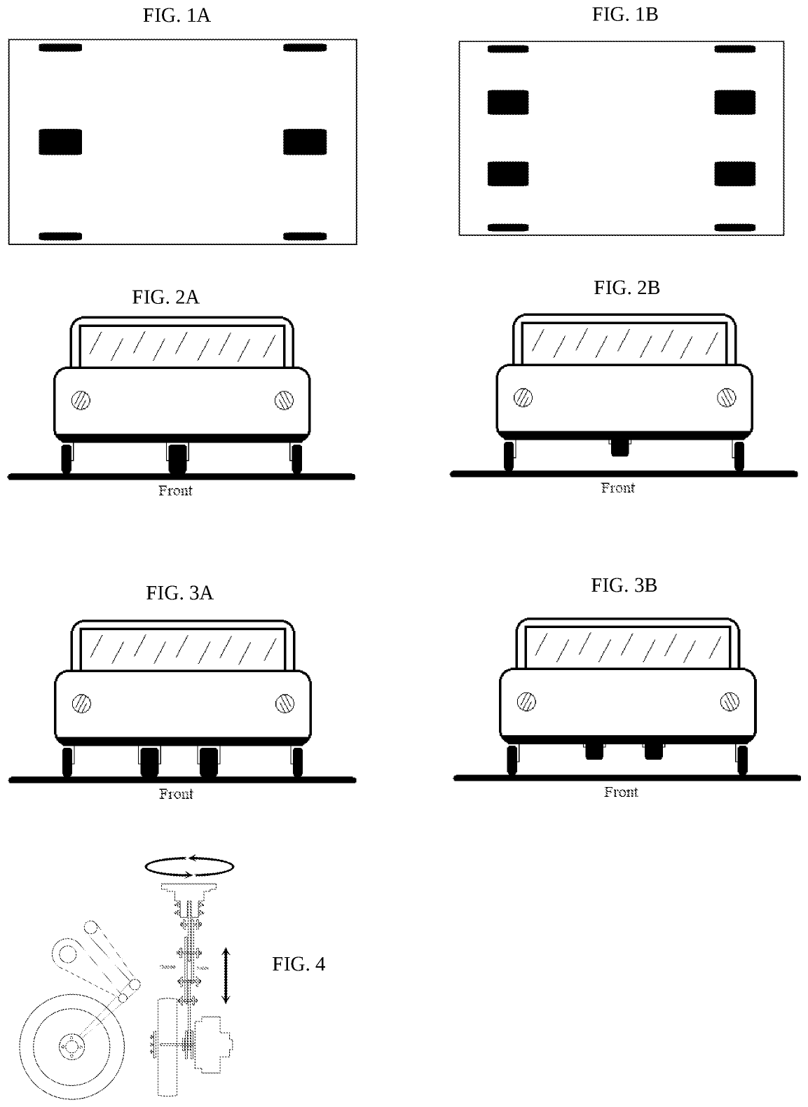

The EV Driveline consists of 4 base wheels, with similar layout to that of current vehicles with a wheel in each corner. There can be at least one wheel between the front two wheels and there can be at least one wheel between the rear two wheels FIG. 1A-B. These additional wheels will provide additional traction for acceleration. When reaching cruising speeds, the additional wheels can retract, leaving only the wheels in each corner in contact with the ground FIGS. 2A-B, 3A-B. This will greatly reduce drag for the majority of any journey. Reducing drag will increase the range per charge of an electric vehicle. When the driver of the vehicle applies the brakes, the additional wheels that are retracted will lower to the ground and greatly increase the vehicles deceleration.

Each wheel can have independent suspension that allows each wheel to raise and lower FIG. 4. Each wheel will be independently powered and can independently rotate. This allows the computer to control each wheel's speed to replace the need for a differential gearbox. The computer will also be able to control the pivoting angle of each wheel for optimal cornering. The braking system will use a regenerative braking system. This will convert braking energy into stored electrical energy. Each wheel will be independently powered by independent electric motors. Each motor will be able to switch to operating as a generator which will generate additional stored electrical energy when the motors are not under load. This means that coasting down a hill will be converted into additional stored electrical energy.

What is claimed is:

1. The EV driveline consists of a set of four wheels, similar to that of the conventional car, along with at least one wheel in the center of the front two wheels and/or at least one wheel in the center of the rear two wheels.

2. In accordance with claim 1, every wheel is independently powered and has independent suspension that can raise and lower each wheel to overcome uneven or rough terrain. The computer can alter each wheel's speed to replace the need for a differential.

3. In accordance with claim 1, the wheel's braking system can be a regenerative braking system to convert the energy required to stop into stored electrical energy. The motors can be switched to operate as generators so when coasting or the motors or not under load, the motion is generating additional stored electrical energy.

4. In accordance with claim 1, the wheels in between the front two wheels and/or the back two wheels increase acceleration power and then can raise when the vehicle reaches cruising speeds, reducing cruising drag. When the driver applies the brakes, said wheels will lower back to the ground for additional braking power.

5. In accordance with claim 1, the EV driveline can reduce the drag and energy consumption of the modern electric vehicle. This will increase the overall range achieved by a single charge.
